(19) United States
(12) Patent Application Publication
(10) Pub. No.: US 2025/0338333 A1
(43) Pub. Date: Oct. 30, 2025

(54) ELECTRONIC DEVICE PERFORMING SUB-CHANNEL COMMUNICATION VIA DIFFERENT MODES

(71) Applicant: BUFFALO INC., Nagoya-shi (JP)

(72) Inventors: Sho SASAKI, Aichi (JP); Hirotaka NARUSE, Aichi (JP)

(73) Assignee: BUFFALO INC., Nagoya-shi (JP)

(21) Appl. No.: 19/084,815

(22) Filed: Mar. 20, 2025

(30) Foreign Application Priority Data
Apr. 26, 2024 (JP) 2024-073238

(51) Int. Cl. H04W 76/14; H04W 84/12

(52) U.S. Cl. CPC H04W 76/14; H04W 84/12

(57) ABSTRACT

A first device that performs wireless LAN communication, includes: a processing circuitry. The processing circuitry is configured to perform communication in any one of a first mode in which communication is performed using all sub-channels included in a sub-channel set including a plurality of continuous sub-channels used in the wireless LAN communication and a second mode in which communication is performed using a part of the sub-channels of the sub-channel set, and disconnect communication with a second device that is unable to communicate in the second mode in response to the processing circuitry starting the communication in the second mode from a state in which the processing circuitry performs the communication in the first mode.

### CROSS-REFERENCE TO RELATED APPLICATION

This application is based on and claims priority under 35 USC 119 from Japanese Patent Application No. 2024-073238 filed on Apr. 26, 2024, the entire content of which is incorporated herein by reference.

### TECHNICAL FIELD

The present disclosure relates to a first device that performs wireless LAN communication.

### BACKGROUND ART

In recent wireless LAN standards, a usable frequency band is divided into a plurality of sub-channels, a sub-channel set obtained by combining a plurality of continuous sub-channels is set, and communication using a wide band is enabled. In this state, in a case where an interference occurs in one of the sub-channels included in the sub-channel set, only the sub-channel subjected to an interference is set not to be used for data transmission, and thus techniques (preamble puncturing) have been developed to ensure data transmission over as wide a bandwidth as possible (for example, JP2023-123698A).

### SUMMARY

According to an aspect of the present disclosure, there is provided a first device that performs wireless LAN communication, including:
a processing circuitry, in which
the processing circuitry is configured to
   perform communication in any one of a first mode in which communication is performed using all sub-channels included in a sub-channel set including a plurality of continuous sub-channels used in the wireless LAN communication and a second mode in which communication is performed using a part of the sub-channels of the sub-channel set, and
   disconnect communication with a second device that is unable to communicate in the second mode in response to the communication in the second mode being started from a state in which the processing circuitry performs the communication in the first mode.

According to another aspect of the present disclosure, there is provided a method performed by processing circuitry of a first device for controlling a first device that performs wireless LAN communication, the method including:
performing communication in any one of a first mode in which communication is performed using all sub-channels included in a sub-channel set including a plurality of continuous sub-channels used in the wireless LAN communication and a second mode in which communication is performed using a part of the sub-channels of the sub-channel set; and
disconnecting communication with a second device that is unable to communicate in the second mode in response to the communication in the second mode being started from a state in which the processing circuitry performs the communication in the first mode.

According to another aspect of the present disclosure, there is provided a communication system including:
a second device; and
a first device that performs wireless LAN communication with the second device, in which
the first device includes a processing circuitry,
the processing circuitry is configured to
   perform communication with the second device in any one of a first mode in which communication is performed using all sub-channels included in a sub-channel set including a plurality of continuous sub-channels used in the wireless LAN communication and a second mode in which communication is performed using a part of the sub-channels of the sub-channel set, and
   disconnect communication with a second device that is unable to communicate in the second mode in response to the communication in the second mode being started from a state in which the processing circuitry performs the communication in the first mode.

### BRIEF DESCRIPTION OF DRAWINGS

Exemplary embodiments of the present disclosure will be described in detail based on the following figures, wherein:

FIG. 1 is a configuration block diagram illustrating an example of a first device according to an embodiment of the present disclosure;

FIG. 2 is a functional block diagram illustrating a configuration example implemented by a control unit of the first device according to the embodiment of the present disclosure;

FIG. 3A is a diagram illustrating an operation example of the first device according to the embodiment of the present disclosure;

FIG. 3B is a diagram illustrating an operation example of the first device according to the embodiment of the present disclosure; and

FIG. 4 is a flowchart illustrating an operation example of the first device according to the embodiment of the present disclosure.

### DESCRIPTION OF EMBODIMENTS

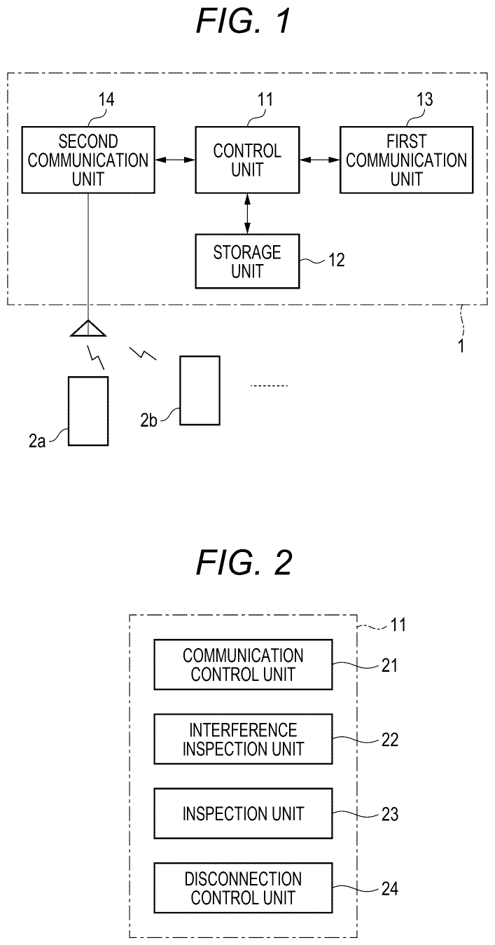

Embodiments of the present disclosure will be described with reference to the drawings. As illustrated in FIG. 1, a first device 1 according to an embodiment of the present disclosure includes a control unit 11, a storage unit 12, a first communication unit 13, and a second communication unit 14. The first device 1 is communicably connected to at least one second device 2a, 2b, . . . . Hereinafter, in a case where it is not necessary to distinguish the second devices from each other, they are collectively referred to as a second device 2. The second device 2 is, for example, a smartphone or a personal computer, and wirelessly transmits and receives data to and from the first device 1.

The control unit 11 is a program control device such as a CPU, and operates in accordance with a program stored in the storage unit 12. The control unit 11 may be implemented by circuit elements, or may be implemented by a general-purpose processor, a dedicated processor, an integrated circuit, an application-specific integrated circuit (ASIC), a circuit of the related art, and a processing circuitry including a combination thereof, which are configured or programmed so as to perform the functions disclosed herein. The processor includes a transistor and other circuit elements therein, and can be regarded as a processing circuitry. In the present disclosure, the circuit elements and the means are hardware configured to perform the functions described above. The hardware may be any hardware disclosed herein, or may be known hardware configured or programmed to perform the functions described above. In a case where the hardware is a processor that can be regarded as a kind of circuit element, the circuit elements and means are a combination of hardware and software, and the software is used for setting the hardware and the processor. In the present embodiment, the control unit 11 controls the second communication unit 14 to perform communication with the second device 2 in any one of a first mode in which communication is performed using all sub-channels included in a sub-channel set including a plurality of continuous sub-channels and a second mode (mode in which communication is performed using a preamble puncturing technique) in which communication is performed using a part of the sub-channels of the sub-channel set.

Since the preamble puncturing is a relatively new technique, even in a case where a first device side such as an access point supports the technique, there are still some second devices that communicate with the first device and that do not support the technique.

In a case where the first device transmits a signal using the preamble puncturing technique, the second device side that does not support the technique cannot demodulate the signal and cannot communicate with the first device.

In view of the above circumstances, the present disclosure relates to enabling an operation in consideration of a second device that does not support the preamble puncturing technique.

In a case where the communication in the first mode is cancelled and the communication in the second mode is started from the state in which the communication is performed in the first mode, the control unit 11 checks whether there is a second device that is unable to communicate in the second mode among the second devices that communicate in the first mode. In a case where it is determined that there is a second device that is unable to communicate in the second mode, the control unit 11 disconnects the communication.

The operation of the control unit 11 will be described later in detail.

The storage unit 12 is a memory device or the like and holds a program to be executed by the control unit 11. The program may be stored and provided in a computer-readable and non-transitory recording medium, and be copied and stored in the storage unit 12. The storage unit 12 also holds various parameter information required for the control unit 11 to execute the program, and also operates as a work memory of the control unit 11.

The first communication unit 13 is, for example, a wired network interface, and is connected to a wide area network (WAN) such as the Internet via a router or the like.

The second communication unit 14 is a wireless LAN interface, and wirelessly transmits and receives data to and from the second device 2 in accordance with an instruction to be input from the control unit 11.

Next, the operation of the control unit 11 will be described. The control unit 11 of the present embodiment controls the second communication unit 14 to wirelessly communicate with the second device 2 using a predetermined frequency band, and transmits information received from the second device 2 via the first communication unit 13 to a server or the like connected to a WAN side. In addition, the control unit 11 operates as a so-called access point, which transmits the information received by the first communication unit 13 from the server or the like connected to the WAN side to a second device 2 side via the second communication unit 14.

By executing the program stored in the storage unit 12, the control unit 11 of the present embodiment functionally implements a configuration including a communication control unit 21, an interference inspection unit 22, an inspection unit 23, and a disconnection control unit 24 as illustrated in FIG. 2.

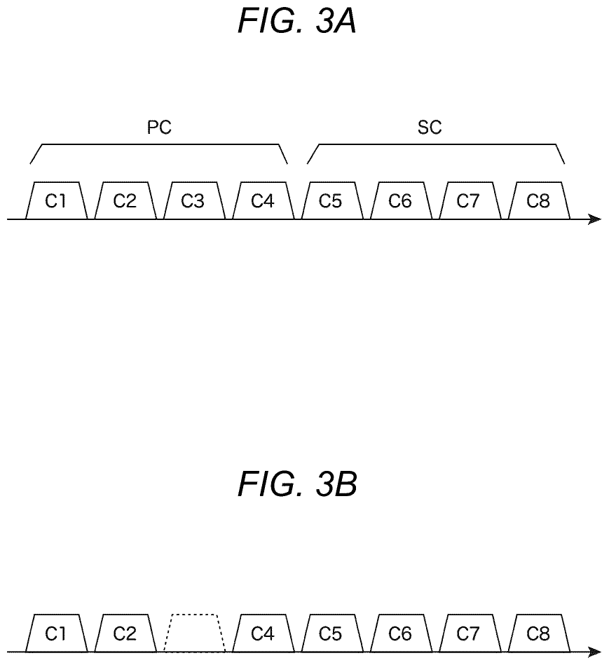

As illustrated in FIGS. 3A and 3B, the communication control unit 21 divides a predetermined frequency band into sub-channels C1, C2, . . . of 20 MHz that do not overlap each other, and uses the sub-channels to perform wireless communication with the second device 2.

The communication control unit 21 controls the second communication unit 14 to set a communication bandwidth of 40 MHz by combining two continuous (adjacent) sub-channels Ci and Ci+1 (i=1, 3, . . . ). Further, the control unit 11 sets a communication bandwidth of 80 MHz by combining two adjacent communication bandwidths of 40 MHz. In this case, one of the communication bandwidths of 40 MHz is a primary channel, and the other is a secondary channel. Similarly, communication bandwidths of 40 MHz, 80 MHz, 160 MHz, . . . are formed by setting a communication bandwidth of 160 MHz using two continuous (adjacent) communication bandwidths of 80 MHz as a set, and operating one of the communication bandwidths of 80 MHz as a primary channel and the other as a secondary channel (this mode is widely known as channel bonding, and thus the detailed description of the processing will be omitted).

In addition, the communication control unit 21 controls the second communication unit 14 to perform communication with the second device 2 in one mode of the first mode and the second mode. Specifically, in a case where the communication is performed in the first mode, the communication control unit 21 controls the second communication unit 14 as follows.

The communication control unit 21 performs the communication in the first mode in a normal state (state in which there is no interference from the outside in any sub-channel used for communication), and controls the second communication unit 14 to perform communication with the second device 2 by using the sub-channel in the sub-channel set including the plurality of continuous sub-channels.

While the communication is performed in the first mode, the second communication unit 14 performs communication with the second device 2 with a bandwidth of 160 MHz using, for example, a sub-channel set including continuous sub-channels C1 to C8 (FIG. 3A). In this case, the communication control unit 21 uses, for example, the sub-channels C1 to C4 as primary channels PC, and the sub-channels C5 to C8 as secondary channels SC.

On the other hand, in a case where an interference occurs in any of the sub-channels used for the communication during the communication in the first mode, the communication control unit 21 starts the communication in the second mode and controls the second communication unit 14 to disable the sub-channel in which the interference occurs as illustrated in FIG. 3B. Then, the communication control unit 21 continues the communication using a sub-channel other than the unusable sub-channels among the sub-channel set used in the communication in the first mode (preamble puncturing). In this case, the sub-channels to be used may be discontinuous. FIG. 3B illustrates an example in which the third channel C3 is disabled.

In a case where the communication transitions from the first mode to the second mode, the communication control unit 21 notifies the second device 2 that communicates in the first mode of a transition to the second mode, for example by notifying the second device 2 of the channel to be used. The operation is widely known as a preamble puncturing operation, and thus the detailed description thereof will be omitted here.

The interference inspection unit 22 checks whether an interference occurs in each of the sub-channels (may include the unusable sub-channels) included in the sub-channel set to be used for communication by the communication control unit 21. Specifically, the interference inspection unit 22 performs carrier sensing on each of the sub-channels, and checks whether an external narrow-band signal interferes with the sub-channel.

In a case where there is a sub-channel for which it is determined that an interference occurs, the interference inspection unit 22 outputs the information for specifying the sub-channel to the communication control unit 21, and causes the communication control unit 21 to start the communication in the second mode.

In a case where it is determined that no interference occurs in any of the sub-channels (including the unusable sub-channels in a case where there are the unusable sub-channels) included in the sub-channel set, the interference inspection unit 22 causes the communication control unit 21 to perform the communication in the first mode. In this example, in a case where the communication control unit 21 performs the communication in the first mode (in this case, there is no unusable sub-channel), in a case where it is determined that no interference occurs in any of the sub-channels included in the sub-channel set, the interference inspection unit 22 ends the processing, and causes the communication control unit 21 to continue the communication in the first mode. In addition, in a case where the communication control unit 21 performs the communication in the second mode, the interference inspection unit 22 may cause the communication control unit 21 to start the communication in the first mode in a case where it is determined that no interference occurs in any of the sub-channels included in the sub-channel set (in this case, all the sub-channels including an unusable sub-channel since there is the unusable sub-channel).

After the communication control unit 21 transitions from the state in which the communication is performed in the first mode to a state in which the communication is performed in the second mode, the inspection unit 23 inspects whether there is a second device 2 that is unable to communicate in the second mode among the second devices 2 that communicate in the first mode. This inspection can be performed, for example, by using any one of widely known methods for inspecting a communication state, such as whether the communication control unit 21 can receive a response from the second device 2 indicating that a data packet has been received after the communication control unit 21 transmits the data packet to the second device 2 within a predetermined time (timeout time) after the packet is transmitted.

As a result of the above inspection, in a case where there is a second device 2 that is unable to communicate in the second mode among the second devices 2 that communicate in the first mode, the inspection unit 23 instructs the disconnection control unit 24 to disconnect communication.

In a case where the disconnection instruction is received from the inspection unit 23, the disconnection control unit 24 executes the processing of disconnecting the communication in the second mode to the second device 2. Specifically, the disconnection processing can be performed by transmitting a Disassociation frame. In an example of the present embodiment, in a case where the disconnection instruction is received from the inspection unit 23, the disconnection control unit 24 transmits a Disassociation frame to all the second devices 2 that communicate in the first mode before the transition to the second mode, and disconnects the communication. All the second devices 2 include second devices 2 that are capable of communicating in the second mode.

In an example of the present embodiment, after the disconnection control unit 24 disconnects the communication with the second device 2, the communication control unit 21 may newly set a sub-channel set including continuous sub-channels (continuous sub-channels that do not include a sub-channel for which it is determined by the interference inspection unit 22 that an interference occurs). The communication in the first mode can be started using the sub-channel set thus set. A width of a frequency band to be used in the communication in the first mode may be different from a width of a frequency band to be used in the communication in the first mode before the communication is disconnected. For example, even in a case where communication is performed with a bandwidth of 160 MHz using eight sub-channels in the communication in the first mode performed before the communication is disconnected, an interference occurs in one of the eight sub-channels, and the number of sub-channels included in the sub-channel set that is set after the transition to the communication in the second mode is performed and the communication is disconnected may be, for example, four. In this case, a width of a communication bandwidth newly set after the disconnection is 80 MHz.

### (Operation)

The first device 1 of the present embodiment basically has the above configuration, and operates as in the following example. In the following description, the first device 1 has a service set identifier (SSID) of “ID1” set as a preset SSID.

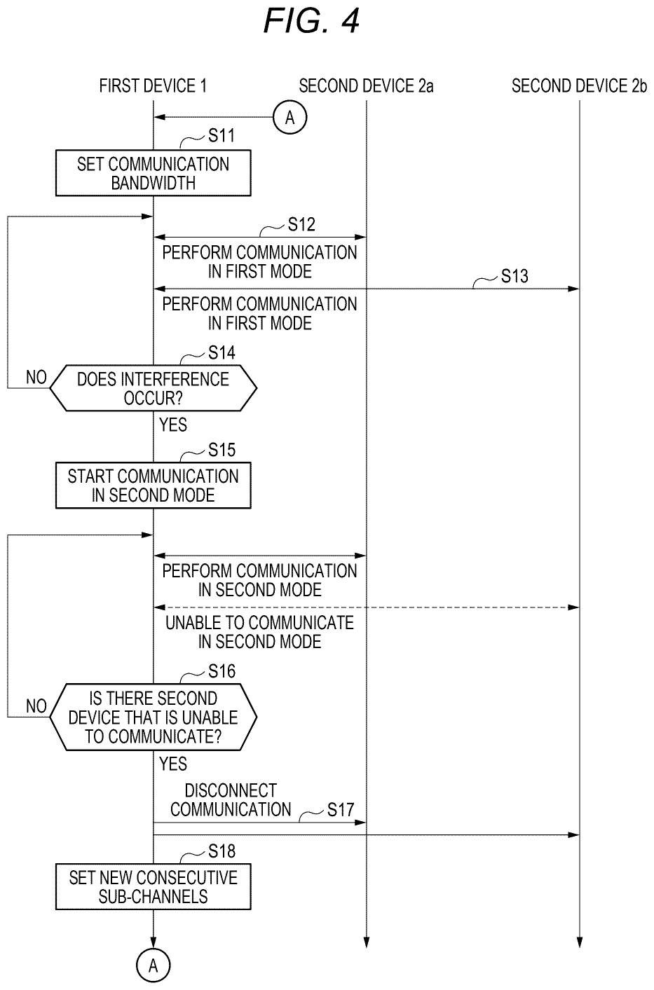

As illustrated in FIG. 4, first, the first device 1 collectively sets the continuous sub-channels C1 to C8 among the sub-channels C1, C2, . . . of 20 MHz as the sub-channel set, sets a communication bandwidth of 160 MHz using all the sub-channels included in the sub-channel set (S11), and performs wireless LAN communication using the communication bandwidth. Here, for example, as illustrated in FIG. 3A, the first device 1 sets the sub-channels C1 to C4 as the primary channels PC, and the sub-channels C5 to C8 as the secondary channels SC.

The second devices 2a and 2b are connected to the first device 1 identified by the “ID1” and start the communication in the first mode (S12 and S13). In the following description, the second device 2a is a second device that supports the preamble puncturing (that is, a second device that is able to communicate in the second mode), and the second device 2b is a second device that does not support the preamble puncturing (that is, a second device that is unable to communicate in the second mode).

The first device 1 acquires and holds information for specifying the second devices 2a and 2b. The information for specifying the second devices 2a and 2b may be, for example, MAC addresses of the second devices 2a and 2b.

After starting the communication, the first device 1 checks whether an interference occurs in each of the sub-channels included in the sub-channel set used for communication (S14). In a case where there is no interference in any of the sub-channels (S14: No), the communication in the first mode is continued. On the other hand, in a case where an interference occurs in any of the sub-channels included in the sub-channel set (S14: Yes), the sub-channel in which an interference occurs is disabled, and the communication in the second mode (communication using the preamble puncturing) is started (S15). For example, in a case where a narrow-band interference occurs in a band of 20 MHz of the sub-channel C3, the first device 1 disables the sub-channel C3 and starts the communication using the sub-channels C1, C2, and C4 to C8.

This communication signal can be decoded by the second device 2a that supports the preamble puncturing, and the communication can be continued. However, this signal cannot be decoded by the second device 2b that does not support the preamble puncturing, and the second device 2b sets the first device 1 identified by the SSID “ID1” to be unable to communicate.

After the communication in the second mode is started, the first device 1 inspects whether there is a second device 2 that is unable to communicate in the second mode among the second devices 2a and 2b that communicate in the first mode (S16). In a case where there is no second device 2 that is unable to communicate in the second mode (S16: No), the communication in the second mode is continued. In this case, the first device 1 may repeatedly execute the processing of step S16.

After the communication transitions from the first mode to the second mode, the first device 1 checks whether an interference occurs in each of the sub-channels (including the unusable sub-channels) included in the sub-channel set used in the first mode. In a case where there is no interference in any of the sub-channels, the first device 1 may set a communication bandwidth of 160 MHz using all the sub-channels included in the sub-channel set, return to the first mode, and continue the communication.

On the other hand, in step S16, in a case where there is the second device 2 that is unable to communicate in the second mode among the second devices 2a and 2b that communicate in the first mode (S16: Yes), the Disassociation frame is transmitted to both the second devices 2a and 2b to disconnect the communication (S17). The first device 1 may transmit a signal for the disconnection (here, a Disassociation frame) via the primary channel. In this example, the second device 2b is unable to communicate, and thus the processing proceeds to step S17, and the communication with both the second devices 2a and 2b is disconnected.

The first device 1 newly sets a sub-channel set including continuous sub-channels (S18). The sub-channel set to be set here is continuous sub-channels different from the set of sub-channels included in the sub-channel set used for communication before the disconnection processing of step S17 (a set of the sub-channels C1 to C8 including the unusable sub-channels in the above example). Specifically, the first device 1 uses the continuous sub-channels that do not include a sub-channel for which it is determined that an interference occurs. In this example, the sub-channel C3 is subjected to an interference, and thus the first device 1 sets the sub-channels C5 to C8 as a sub-channel set in step S18. The first device 1 returns to step S11 (A) and sets a communication bandwidth of 80 MHz using the sub-channel set determined in step S18. Then, the first device 1 restarts the communication in the first mode with the SSID “ID1”.

In this case, the first device 1 may transmit a beacon signal for guiding the sub-channel included in the sub-channel set that is set in step S18, and prompt the second devices 2a and 2b in which the communication is disconnected in step S17 to restart the communication. Alternatively the first device 1 may wait until a probe request is received without transmitting a beacon signal notifying of the SSID. In this case, in a case where the second devices 2a and 2b make a probe request to the first device 1 specified by the “ID1” based on a history of previous communication, the first device 1 responds to a probe response. In this case, the second devices 2a and 2b can also restart the communication.

Furthermore, by transmitting a signal (Channel Switch Announcement (CSA) frame or the like) indicating that the sub-channel has been switched, the first device 1 may prompt the restart of communication with the second devices 2a and 2b which are previous communication destinations.

In this example, once the communication is disconnected, the second devices 2a and 2b can newly try to connect to the first device 1, and the communication is restarted.

On the other hand, in a case where the communication is disconnected in step S17, the second devices 2a and 2b can also be connected to another first device. After the communication is disconnected in step S17, the first device 1 of the present embodiment may wait for a period of time before executing the processing in step S18 and thereafter, or may stop an operation for at least a certain period of time without executing the processing in step S18 and thereafter.

In another example of the present embodiment, after the communication is disconnected in step S17, the processing returns to step S15 to restart the communication in the second mode. In this case, the second device 2a can restart the communication by being reconnected to the first device 1, and the second device 2b can attempt to communicate with another first device.

(Example of Disconnecting Only Second Device that is Unable to Communicate)

In the above description, in a case where the disconnection instruction is received from the inspection unit 23, the disconnection control unit 24 transmits a Disassociation frame to all the second devices 2 that communicate in the first mode, before the transition to the second mode, and disconnects the communication. All the second devices 2 include second devices 2 that are capable of communicating in the second mode. The present embodiment is not limited to this example.

For example, in a case where the control unit 11 of the first device 1 receives a disconnection instruction from the inspection unit 23 as an operation of the disconnection control unit 24, the control unit 11 may transmit a Disassociation frame to disconnect the communication only to, among the second devices 2 that communicate in the first mode, a second device 2 which is determined to be unable to communicate in the second mode by the inspection unit 23.

In this example, only the second device 2 that supports the preamble puncturing and is capable of communicating in the second mode continues the communication with the first device 1. In this case, the first device 1 may continue the communication in the second mode. On the other hand, the communication with the first device 1 of the present embodiment is disconnected in the second device 2 that does not support the preamble puncturing, and thus a processing such as trying to connect to another first device (first device specified by an SSID different from the SSID used by the first device 1 at the time of disconnection) is performed.

### (Example of Setting New Service)

As described above, in a case where the communication is disconnected only for the second device 2 which is determined to be unable to communicate in the second mode, the first device 1 may start the communication in the first mode corresponding to the second device 2 with which communication is disconnected in parallel with the communication in the second mode that is being continued (for example, in parallel in a time-division manner).

In this example, the first device 1 generates a new SSID different from the SSID used by the first device 1 at the time of disconnection. Similar to the processing in step S18 in FIG. 4, the first device 1 newly sets a sub-channel set including continuous sub-channels. The sub-channel set to be set here is continuous sub-channels different from the set of sub-channels included in the sub-channel set used for communication before the disconnection processing (a set of the sub-channels C1 to C8 including the unusable sub-channels in the above example).

For example, the first device 1 may use the continuous sub-channels that do not include a sub-channel for which it is determined that an interference occurs, and in a case where communication is performed in a time-division manner with the communication in the second mode that is being continued, a channel included in the sub-channel set newly set here may overlap the sub-channel used in the communication in the second mode. In a case in which the sub-channel C3 is subjected to an interference as an example, a communication bandwidth of 80 MHz is set by newly setting the sub-channels C5 to C8 as a sub-channel set. Then, using the newly generated SSID, the first device 1 starts the communication in the first mode while sharing a frequency band in a time-division manner with communication of an original SSID (communication in the second mode, that is, communication using the preamble puncturing).

In this way, the disconnected second device 2 that does not support the preamble puncturing can be reconnected to the first device 1 identified by the newly set SSID and can perform the communication in the first mode. In this case, the first device 1 may transmit a beacon signal for guiding the sub-channel, and prompt the preamble puncturing non-support second device 2 in which the communication is disconnected to restart the communication. Alternatively, by transmitting a signal (CSA frame or the like) indicating that the sub-channel has been switched, the first device 1 may prompt the restart of communication with the preamble puncturing non-support second device 2 which is a previous communication destination.

As described above, the following matters are disclosed in the present specification.

According to an aspect of the present disclosure, there is provided a first device that performs wireless LAN communication, including:
a processing circuitry, in which
the processing circuitry is configured to
   perform communication in any one of a first mode in which communication is performed using all sub-channels included in a sub-channel set including a plurality of continuous sub-channels used in the wireless LAN communication and a second mode in which communication is performed using a part of the sub-channels of the sub-channel set, and
   disconnect communication with a second device that is unable to communicate in the second mode in response to the processing circuitry starting the communication in the second mode from a state in which the processing circuitry performs the communication in the first mode.

According to the first device of the present disclosure, by disconnecting the communication in a case where there is a second device that is unable to communicate in the second mode (mode in which communication is performed using a preamble puncturing technique), it is possible to perform a processing in consideration of the second device that does not support the preamble puncturing technique, such as giving an opportunity of reconnection to the second device.

The processing circuitry may be configured to disconnect the second device that communicates in the second mode in a case where there is a second device that is unable to communicate in the second mode, or to disconnect communication with only the second device that is unable to communicate in the second mode in a case where there is a second device that is unable to communicate in the second mode.

According to this example, by disconnecting the communication of the second device that is unable to communicate in the second mode, it is possible to perform a processing in consideration of the second device that does not support the preamble puncturing technique, such as giving an opportunity of reconnection to the second device.

The processing circuitry may be configured to start the communication using the continuous sub-channels set after the disconnection processing

According to this aspect, the first device can restart the communication with the second device that is unable to communicate in the second mode in a band including the continuous sub-channels.

The processing circuitry may be configured to start the communication using the continuous sub-channels set after the disconnection processing, and the continuous sub-channels may be continuous sub-channels different from a set of sub-channels included in the sub-channel set used for communication before the disconnection processing.

According to this aspect, the first device can restart communication with the second device that is unable to communicate in the second mode in the band including the continuous sub-channels different from the set of the sub-channels included in the sub-channel set used for communication before the disconnection processing.

In a case where the processing circuitry disconnects the communication in the second mode, the processing circuitry may transmit a signal for instructing disconnection on a primary channel.

According to another aspect of the present disclosure, there is provided a method performed by processing circuitry of a first device for controlling a first device that performs wireless LAN communication, the method including:
performing communication in any one of a first mode in which communication is performed using all sub-channels included in a sub-channel set including a plurality of continuous sub-channels used in the wireless LAN communication and a second mode in which communication is performed using a part of the sub-channels of the sub-channel set; and
disconnecting communication with a second device that is unable to communicate in the second mode in response to the communication in the second mode from a state in which the processing circuitry performs the communication in the first mode.

According to the method of the present disclosure, by disconnecting the communication in a case in which there is a second device that is unable to communicate in the second mode, it is possible to perform a processing in consideration of the second device that does not support the preamble puncturing technique, such as giving an opportunity of reconnection to the second device.

According to another aspect of the present disclosure, there is provided a communication system including:
a second device; and
a first device that performs wireless LAN communication with the second device, in which
the first device includes a processing circuitry,
the processing circuitry is configured to
   perform communication with the second device in any one of a first mode in which communication is performed using all sub-channels included in a sub-channel set including a plurality of continuous sub-channels used in the wireless LAN communication and a second mode in which communication is performed using a part of the sub-channels of the sub-channel set, and
   disconnect communication with a second device that is unable to communicate in the second mode in response to the processing circuitry starting the communication in the second mode from a state in which the processing circuitry performs the communication in the first mode.

According to the communication system of the present disclosure, by disconnecting the communication in a case in which there is a second device that is unable to communicate in the second mode, it is possible to perform a processing in consideration of the second device that does not support the preamble puncturing technique, such as giving an opportunity of reconnection to the second device.

According to another aspect of the present disclosure, there is provided a non-transitory computer-readable storage medium storing a program for causing a computer to execute the above control method.

According to the non-transitory computer-readable storage medium of the present disclosure, by disconnecting the communication in a case in which there is a second device that is unable to communicate in the second mode, it is possible to perform a processing in consideration of the second device that does not support the preamble puncturing technique, such as giving an opportunity of reconnection to the second device.

According to the present disclosure, it is possible to perform a processing in consideration of the second device that does not support the preamble puncturing technique.

What is claimed is:

1. A first device that performs wireless LAN communication, comprising:
a processing circuitry, wherein
the processing circuitry is configured to
perform communication in any one of a first mode in which communication is performed using all sub-channels included in a sub-channel set including a plurality of continuous sub-channels used in the wireless LAN communication and a second mode in which communication is performed using a part of the sub-channels of the sub-channel set, and
disconnect communication with a second device that is unable to communicate in the second mode in response to the processing circuitry starting the communication in the second mode from a state in which the processing circuitry performs the communication in the first mode.

2. The first device according to claim 1, wherein
the processing circuitry is configured to disconnect the second device that communicates in the second mode in a case where there is a second device that is unable to communicate in the second mode.

3. The first device according to claim 1, wherein
the processing circuitry is configured to disconnect communication with only the second device that is unable to communicate in the second mode in a case where there is a second device that is unable to communicate in the second mode.

4. The first device according to claim 2, wherein
the processing circuitry is configured to start the communication using the continuous sub-channels set after the disconnection processing.

5. The first device according to claim 3, wherein
the processing circuitry is configured to start the communication using the continuous sub-channels set after the disconnection processing.

6. The first device according to claim 2, wherein
the processing circuitry is configured to start the communication using the continuous sub-channels set after the disconnection processing, and
the continuous sub-channels are continuous sub-channels different from a set of sub-channels included in the sub-channel set used for communication before the disconnection processing.

7. The first device according to claim 3, wherein
the processing circuitry is configured to start the communication using the continuous sub-channels set after the disconnection processing, and
the continuous sub-channels are continuous sub-channels different from a set of sub-channels included in the sub-channel set used for communication before the disconnection processing.

8. The first device according to claim 1, wherein
in a case where the processing circuitry disconnects the communication in the second mode, the processing circuitry transmits a signal for instructing disconnection on a primary channel.

9. The first device according to claim 2, wherein
in a case where the processing circuitry disconnects the communication in the second mode is disconnected, the processing circuitry transmits a signal for instructing disconnection on a primary channel.

10. The first device according to claim 3, wherein
in a case where the processing circuitry disconnects the communication in the second mode, the processing circuitry transmits a signal for instructing disconnection on a primary channel.

11. The first device according to claim 1, wherein
the processing circuitry starts the communication in the second mode in a state in which the processing circuitry performs the communication in the first mode in a case where an interference occurs in any of the sub-channels.

12. The first device according to claim 1, wherein
the processing circuitry starts the communication in the first mode in response to it being determined that no interference occurs in any of the sub-channels in a state in which the processing circuitry performs the communication in the second mode due to occurrence of an interference in any of the sub-channels.

13. The first device according to claim 1, wherein
the processing circuitry does not perform the communication in the first mode and the communication in the second mode for a predetermined period after the processing circuitry disconnects the communication with the second device that is unable to communicate in the second mode.

14. The first device according to claim 3, wherein
the processing circuitry sets continuous sub-channels in parallel with the communication in the second mode with a second device that is capable of communicating in the second mode after the processing circuitry disconnects the communication with only the second device that is unable to communicate in the second mode, and starts the communication with the second device that is unable to communicate in the second mode using the sub-channels set by the processing circuitry.

15. A method performed by processing circuitry of a first device for controlling the first device that performs wireless LAN communication, the method comprising:
performing communication in any one of a first mode in which communication is performed using all sub-channels included in a sub-channel set including a plurality of continuous sub-channels used in the wireless LAN communication and a second mode in which communication is performed using a part of the sub-channels of the sub-channel set; and
disconnecting communication with a second device that is unable to communicate in the second mode in response to the processing circuitry stating the communication in the second mode from a state in which the processing circuitry performs the communication in the first mode.

16. A communication system comprising:
a second device; and
a first device that performs wireless LAN communication with the second device, wherein
the first device includes a processing circuitry,
the processing circuitry is configured to
perform communication with the second device in any one of a first mode in which communication is performed using all sub-channels included in a sub-channel set including a plurality of continuous sub-channels used in the wireless LAN communication and a second mode in which communication is performed using a part of the sub-channels of the sub-channel set, and
disconnect communication with a second device that is unable to communicate in the second mode in response to the processing circuitry starting the communication in the second mode from a state in which the processing circuitry performs the communication in the first mode.

17. A non-transitory computer-readable storage medium storing a program for causing a computer to execute the control method according to claim 15.
